(19) United States
(12) Patent Application Publication
(10) Pub. No.: US 2022/0041276 A1
(43) Pub. Date: Feb. 10, 2022

(54) AIRCRAFT, AND THE PRODUCTION THEREOF

(71) Applicant: Dr. Ing. h.c. F. Porsche Aktiengesellschaft, Stuttgart (DE)

(72) Inventors: Patrick Scholl, Bietigheim-Bissingen (DE); Jens-Ole Thoebel, Hankensbuettel (DE); Christian Wenzel, Untergruppenbach (DE)

(21) Appl. No.: 17/394,439

(22) Filed: Aug. 5, 2021

(30) Foreign Application Priority Data
Aug. 10, 2020 (DE) 10 2020 121 032.9

(51) Int. Cl. B64C 29/00; B64C 11/00

(52) U.S. Cl. CPC B64C 29/0025; B64C 11/001

(57) ABSTRACT

An aircraft includes wings with integrated ducted fans. The ducted fans each have a duct, and each respective duct is made up of inlet regions and outlet regions. Different ducts of different ducted fans can have different construction variants, but the outlet regions of respective ducts can be of identical or mirror-symmetrical shape with respect to one another in all construction variants.

### CROSS REFERENCE TO RELATED APPLICATIONS

This application claims benefit to German Patent Application No. DE 10 2020 121 032.9, filed on Aug. 10, 2020, which is hereby incorporated by reference herein.

### FIELD

The present disclosure relates to an aircraft, in particular a fully electric vertical take-off and landing (VTOL) aircraft, and to an advantageous method for producing such an aircraft.

### BACKGROUND

VTOL is the cross-language name given in the aerospace industry to any type of aircraft, drone or rocket that has the capability of lifting off and landing again substantially vertically and without a runway. This collective term is used below in a broad sense that includes not just fixed-wing aircraft with wings, but rather also rotary-wing aircraft such as helicopters, gyrocopters, gyrodynes and hybrids such as composite or combination helicopters and convertiplanes. Short take-off and landing (STOL) aircraft, short take-off and vertical landing (STOVL) aircraft and vertical take-off and horizontal landing (VTHL) aircraft are also included.

EP 2 193 993 A2 discloses a fan duct which is made up substantially of annular components.

WO 2005/032939 A1 proposes the production of a fan duct in a segmented construction in the manner of a modular system.

U.S. Pat. No. 7,712,701 B1 and CN 205770158 U describe fan ducts which are produced from individual circumferential segments.

### SUMMARY

In an embodiment, the present disclosure provides an aircraft. The aircraft includes wings with integrated ducted fan. The ducted fans each have a duct, and each respective duct is made up of inlet regions and outlet regions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the isometric view of a wing with partially transparent cladding and outer skin;

FIG. 2 shows the isometric view of the ducted fan of the wing without motor;

FIG. 3 shows a view, corresponding to FIG. 2, from an elevated perspective;

FIG. 4 shows the isometric view of a fan with partially transparent inlet and outlet;

FIG. 5 shows the isometric view of the honeycomb cores of two ducts with inserts;

FIG. 6 shows the front view of two duct parts in different construction variants;

FIG. 7 shows a view, corresponding to FIG. 5, of the complete duct with partially transparent inlet and outlet; and

FIGS. 8 to 10 illustrate the fitted connection between duct and guide grille.

### DETAILED DESCRIPTION

The present disclosure describes an aircraft, in particular a fully electric vertical take-off and landing aircraft in the above sense, and a method for producing such a vehicle.

The approach according to the present disclosure is based on the insight that a VTOL aircraft that can be used in urban environments requires drive units in different positions and orientations, which drive units are on the one hand capable of handling every phase of flight (take-off, transition, cruise and landing) but on the other hand do not exceed a manageable number of individual parts.

For the lift of the aircraft, it is the case here that, instead of an exposed rotor, ducted fans are provided which are integrated into the wing surface, such as are known, outside the aerospace sector, for example from hovercraft or swamp craft. The cylindrical housing of the air channel, which can be referred to hereinafter as a duct, reduces the shear losses that arise owing to turbulence at the blade tips of such a ducted fan.

According to the present disclosure, the ducts of the fans have different inlet and outlet regions such that they can be manufactured using a common tool, which is however of modular construction. One advantage of this approach lies in the resulting cost saving.

Further advantageous configurations are specified herein. For example, outlet regions may be of corresponding or mirror-symmetrical shape in all construction variants. It is thus possible for the lower part of the tool to be used universally, and for an individual duct to be manufactured merely by way of combination with a suitable upper part.

Finally, the ducts may have honeycomb cores with inserts which are coated in multiple layers with carbon-fiber-reinforced plastic. Honeycomb cores and inserts can thus be used multiply for different variants.

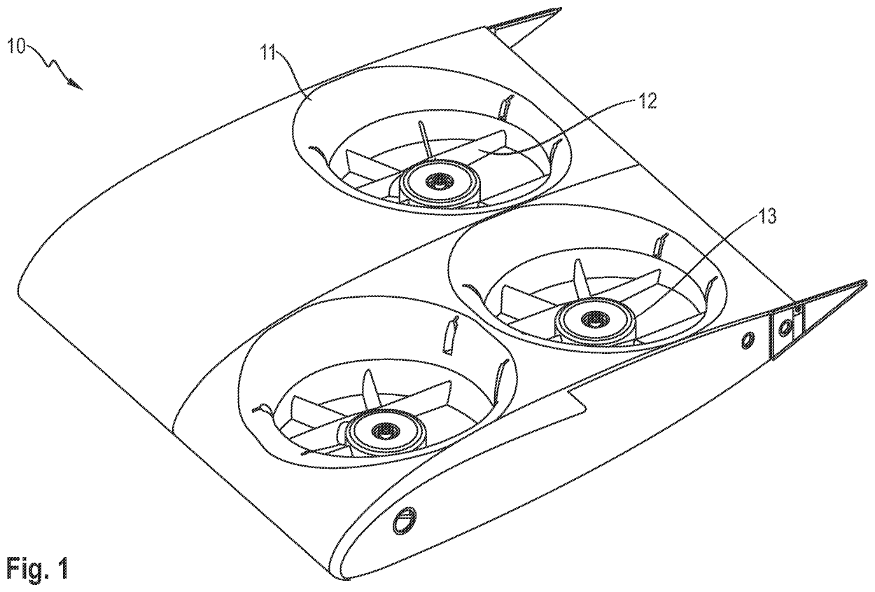

FIG. 1 illustrates the construction of a wing (10) for a selectively fully autonomously or manually controlled aircraft, which wing is divided approximately into quadrants by spars and ribs. In three of these quadrants, there is integrated in each case one ducted fan, the guide grille (12) of which, arranged within the duct (11), supports a central electric motor (13). For this purpose, the three cylindrical electric motors (13) are screwed radially to the respective guide grille (12) such that the struts thereof, manufactured from carbon-fiber-reinforced plastic (CFRP), are capable of supporting the electric motor (13) in an axially and rotationally symmetrical arrangement from opposite sides.

In the illustrated configuration, two of the struts of each guide grille (12) run parallel to one another in the incident-flow direction of the wing (10) and tangentially flank the associated electric motor (13). In each case two beams, joined to said webs, combine with the beams of the respective other web, which are situated diametrically oppositely in relation to the motor (13), to form a St Andrew's or diagonal cross and stiffen the electric motor (13) such that the guide grille (12) accommodates all horizontal forces in the plane of the motor. As is suggested in the figure, the struts of the guide grille (12) have, for this purpose, a width which corresponds approximately to the height of the electric motor (13).

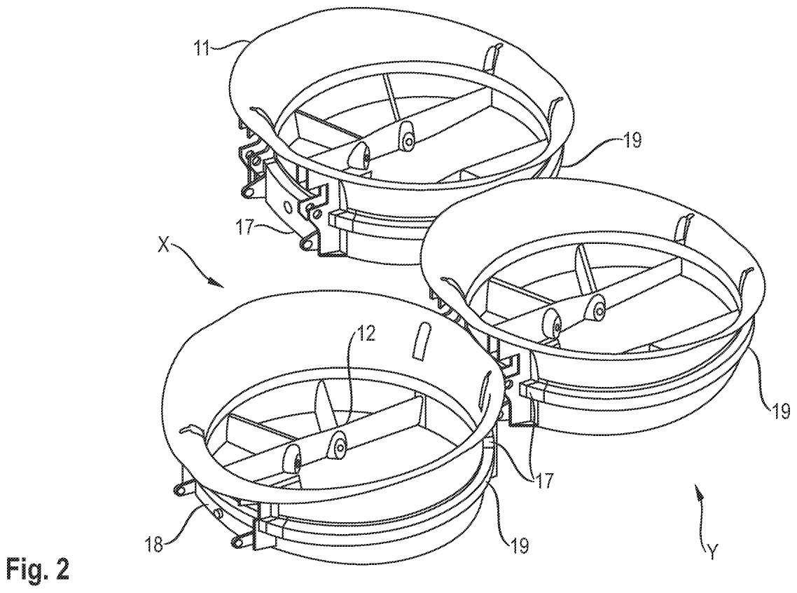

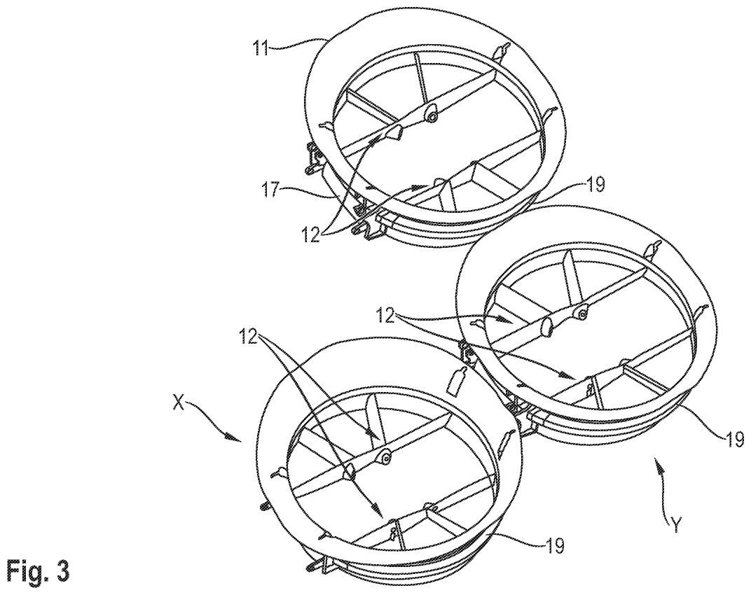

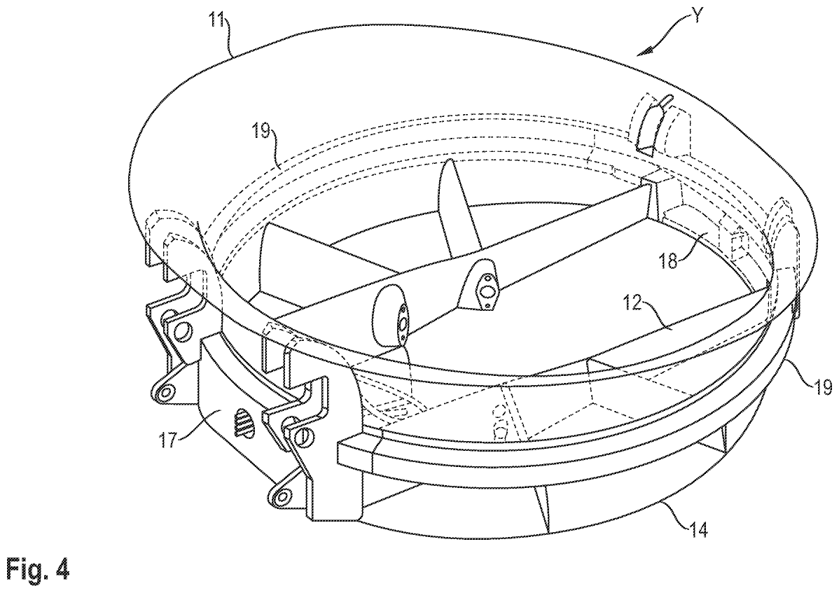

FIGS. 2 and 3 illustrate the different construction variants (X, Y) of the duct (11). This formation of variants is made possible by means of the modular system illustrated in FIG. 4 on the basis of the construction variant Y, in which the duct (in this case: 11, 14) is made up of inlet regions (11) and outlet regions (14) which, across all construction variants (X, Y), can be manufactured by means of one tool with a universal lower part.

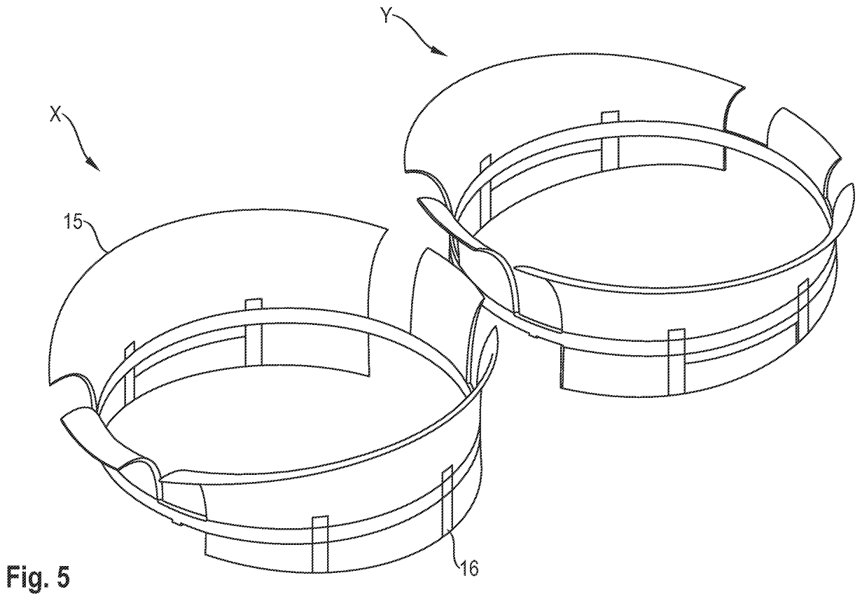

FIG. 5 illustrates the construction of the individual ducts (11, 14) from honeycomb cores (15) with inserts (16) which, after the assembly process, are preferably coated in multiple layers with CFRP. In the present context, this is to be understood to mean any composite material in which carbon fibers are embedded into a plastics matrix that serves for connecting the fibers and for filling the intermediate spaces. As a matrix, aside from conventional epoxy resin, use may also be made of other thermosets or thermoplastics.

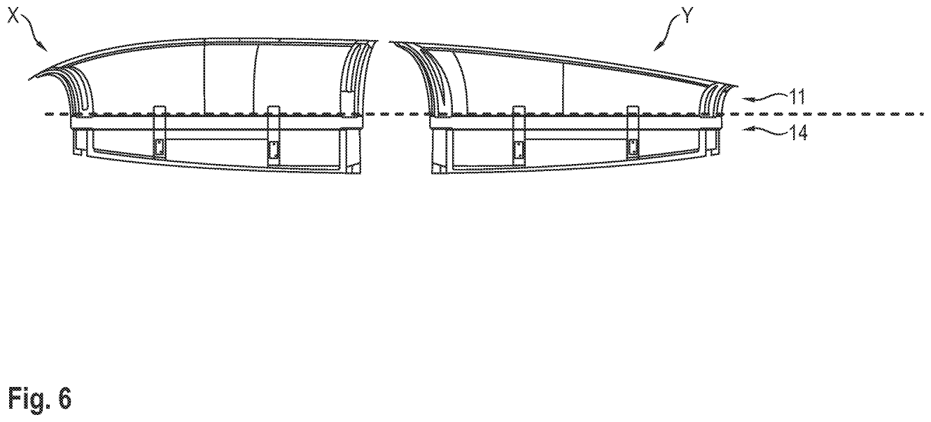

As illustrated by FIG. 6, this modular approach in the present embodiment is promoted by the geometrical relationships of the ducts (11, 14): whereas each duct (11, 14) requires a specific inlet region (11), the outlet regions (14) are in all construction variants (X, Y) geometrically congruent, that is to say can be converted into one another by parallel displacement, rotation, mirroring or combinations of the abovementioned congruence transformations or movements.

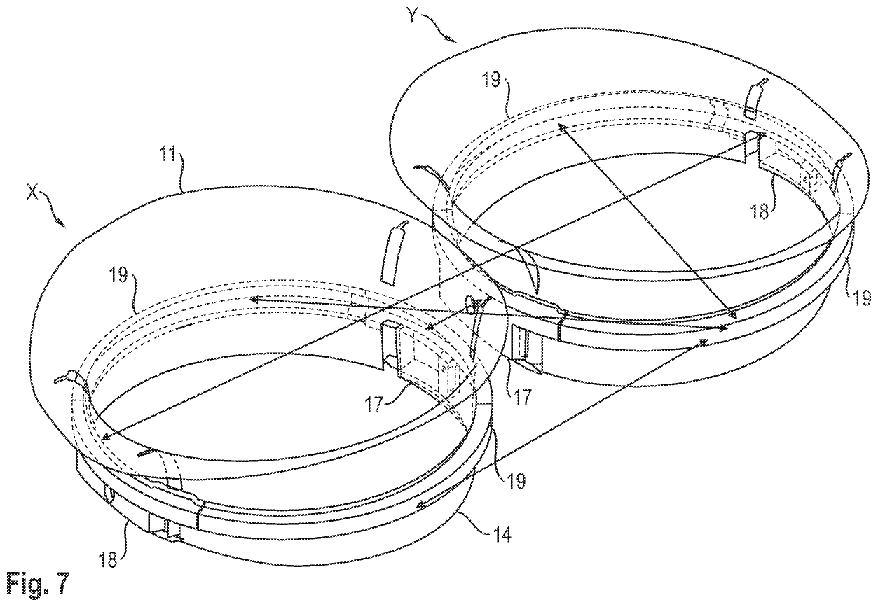

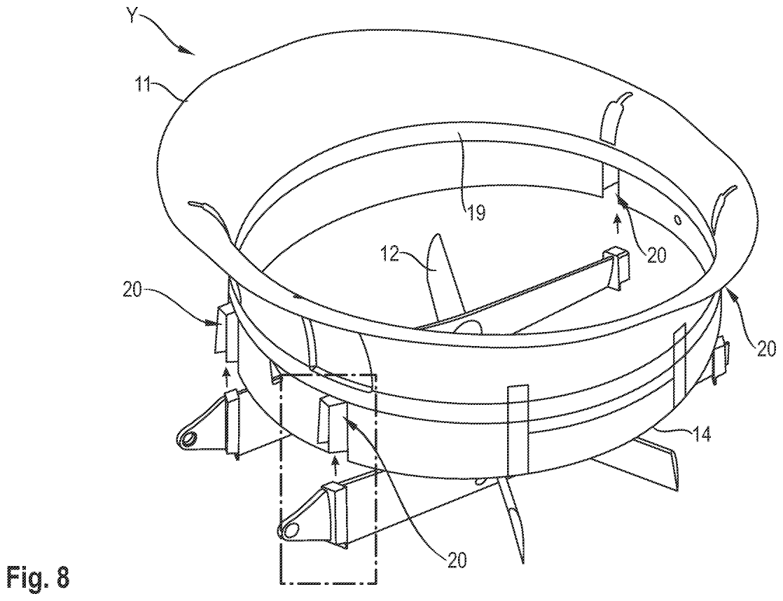

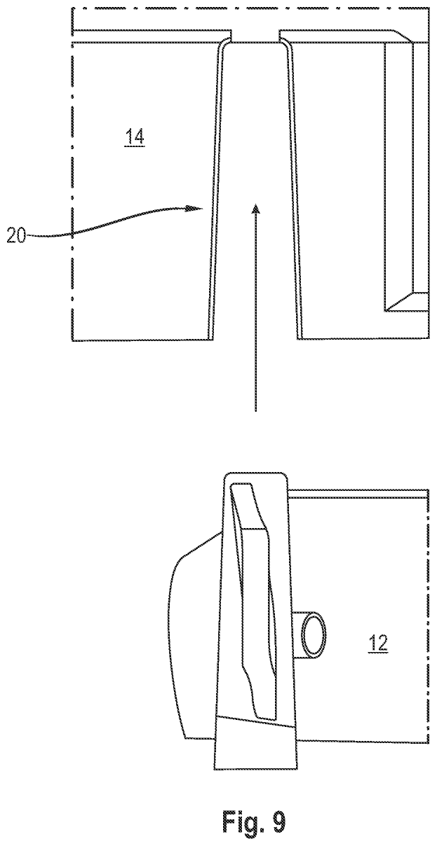

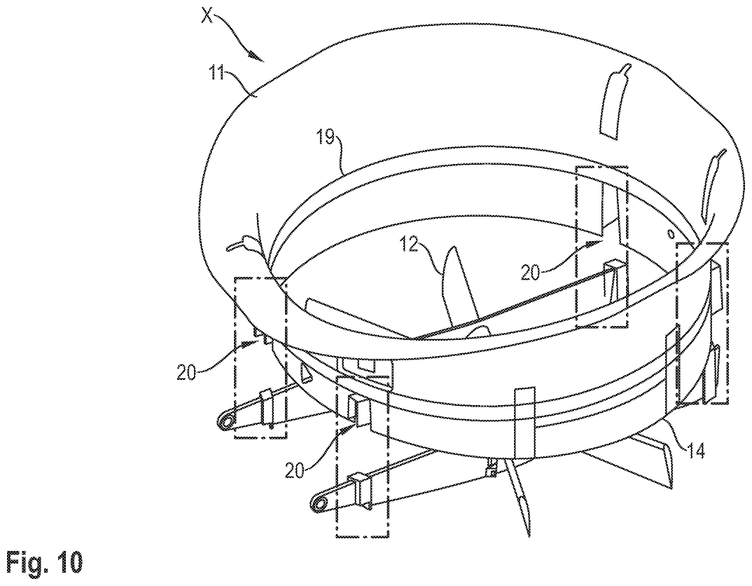

The ducts (11, 14) which, as it were, are “assembled” from these specific inlet regions (11) and universal outlet regions (14) can be stiffened by means of multi-part rings (17, 18, 19) in the manner illustrated in FIG. 7. A juxtaposition of FIGS. 8, 9 and 10 illustrates, on the basis of two exemplary ducts (in this case: 11, 14, 19) of the two construction variants, how the associated guide grille can ultimately, by means of radial cutouts (20) of the outlet regions (14), be fitted into the latter from below as viewed in the figure.

In the present embodiment, the electric motor (13—FIG. 1) is designed as an air-cooled internal-rotor motor with integrated controller. It is self-evident that, in an alternative configuration, use may for example be made of an external-rotor motor or a liquid-type cooling arrangement. Further exemplary options are disclosed for example by DUFFY, Michael, et al. Propulsion scaling methods in the era of electric flight. in: 2018 AIAA/IEEE Electric Aircraft Technologies Symposium (EATS). IEEE, 2018. pp. 1-23.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An aircraft, comprising:
wings with integrated ducted fans,
wherein the ducted fans each have a duct which is made up of inlet regions and outlet regions.

2. The aircraft as claimed in claim 1, wherein respective ducts of different ducted fans have different construction variants, and
wherein the outlet regions are of identical or mirror-symmetrical shape with respect to one another in all construction variants.

3. The aircraft as claimed in claim 1, wherein the ducts have honeycomb cores with inserts, and
wherein the ducts are coated in multiple layers with carbon-fiber-reinforced plastic.

4. The aircraft as claimed in claim 1, wherein the ducted fans each comprise a guide grille and an electric motor supported by the guide grille, and
wherein the outlet regions have cutouts for the fitting of the guide grilles.

5. The aircraft as claimed in claim 1, wherein the ducts each have an encircling stiffness ring.

6. The aircraft as claimed in claim 1, wherein the aircraft comprises substantially perpendicular fans for generating propulsion.

7. The aircraft as claimed in claim 6, wherein the substantially perpendicular fans are further ducted fans.

8. The aircraft as claimed in claim 1, wherein the electric motors each comprise an integrated controller.

9. The aircraft as claimed in claim 1, wherein the aircraft is able to be selectively controlled in a fully autonomous manner.

10. A method for producing an aircraft as claimed in claim 1, wherein the ducts are in each case made up of specific inlet regions and universal outlet regions, and
wherein the ducted fans are inserted into the wings in different installation positions.
